(19) United States
(12) Patent Application Publication
(10) Pub. No.: US 2026/0097615 A1
(43) Pub. Date: Apr. 9, 2026

(54) TRAILER HITCH SYSTEM WITH HITCH PIN KEEPER

(71) Applicant: DANNY WIPF, LAKE ANDES, SD (US)

(72) Inventor: DANNY WIPF, LAKE ANDES, SD (US)

(21) Appl. No.: 18/907,771

(22) Filed: Oct. 7, 2024

(51) Int. Cl. B60D 1/52; B60D 1/02

(52) U.S. Cl. CPC B60D 1/07; B60D 1/02; B60D 1/52

(57) ABSTRACT

A convertible hitch apparatus for removably mounting on a vehicle hitch receiver tube may include a mount structure for mounting on the receiver tube, a lower hitch structure including a lower ball mount, and an upper hitch structure on the mount structure above the lower hitch structure. The upper hitch structure may comprise a support frame and an upper ball mount movably mounted on the support frame. The upper ball mount may comprise a tongue element movably mounted on the support frame to pivot between deployed and inactive positions, a pivot pin pivotally mounting the tongue element on the support frame, a locking pin mountable on the support frame to selectively block the tongue element in the deployed position, and a hitch pin removably insertable into a tongue aperture of the tongue element. A hitch pin retaining element may selectively block removal of the hitch pin from the tongue aperture.

### BACKGROUND

### Field

The present disclosure relates to tow hitching structures and more particularly pertains to a new trailer hitch system with a hitch pin keeper for providing a versatile trailer hitch apparatus with conveniently employable safety features.

### Description of the Prior Art

Vehicles often tow or pull other vehicles, or trailers, behind them using a large variety of different hitching structures.

As an example of some of the different towing structures utilized, many towing structures include a ball mount on the towing vehicle and a ball receiver on the towed trailer. In other towing structures, such as a clevis hitch, the towing element of the towed vehicle is a pair of vertically spaced tongues to be positioned above and below the single flat tongue on the towed vehicle. A variation of the clevis hitch has the pair of vertically spaced tongues may comprise the towing elements on the towed vehicle, and the single tongue on the towing trailer may be positioned between the vertically spaced tongues. Still other towing structures may utilize a pintle hitch on the towing vehicle and a lunette ring on the towed vehicle.

### SUMMARY

In some aspects, the present disclosure relates to a convertible hitch apparatus for removably mounting on a hitch receiver tube of a vehicle, and the hitch apparatus may be elongated along a longitudinal axis. The hitch apparatus may comprise a mount structure for mounting on the hitch receiver tube. The mount tube assembly may comprise an insertion portion at least partially insertable into a tube interior of the receiver tube and a protrusion portion extending from the insertion portion. The hitch apparatus may include a lower hitch structure including a lower ball mount on the mount structure and an upper hitch structure on the mount structure above the lower hitch structure. The upper hitch structure may have a deployed condition and an inactive condition. The upper hitch structure may comprise a support frame on the protrusion portion and an upper ball mount movably mounted on the support frame. The upper ball mount may comprise a tongue element movably mounted on the support frame to pivot between a deployed position corresponding to the deployed condition and an inactive position corresponding to the inactive condition. The tongue element may have a tongue aperture. The upper hitch structure may comprise a pivot pin pivotally mounting the tongue element on the support frame, a locking pin removably mountable on the support frame in a manner such that the locking pin selectively blocks the tongue element in the deployed position, and a hitch pin removably insertable into the tongue aperture of the tongue element. The upper hitch structure may include a hitch pin retaining element for selectively blocking removal of the hitch pin from the tongue aperture.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of a hitch apparatus of a new trailer hitch system with hitch pin keeper with the upper mount structure in the deployed position and the retaining element in the retaining position, according to the present disclosure.

FIG. 2 is a schematic perspective view of the hitch apparatus with the hitch pin removed, according to an illustrative embodiment.

FIG. 3 is a schematic perspective view of the hitch apparatus with the hitch pin removed and the upper mount structure moved to the inactive position and the retaining element moved to the release position, according to an illustrative embodiment.

FIG. 4 is a schematic perspective view of the hitch apparatus with the hitch pin removed and the upper mount structure moved to the inactive position and the retaining element moved to the release position, according to an illustrative embodiment.

FIG. 5 is a schematic side view of the hitch apparatus, according to an illustrative embodiment.

FIG. 6 is a schematic perspective view of the pin retaining element isolated from other elements of the hitch apparatus, according to an illustrative embodiment.

FIG. 7 is a schematic block diagram of the hitch system, according to an illustrative embodiment.

### DETAILED DESCRIPTION

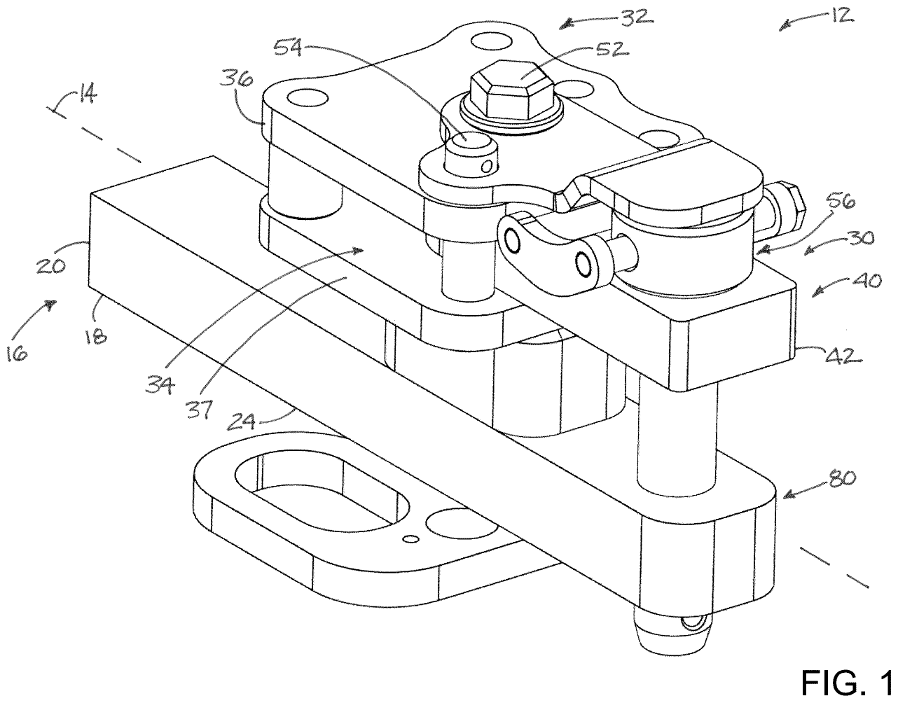

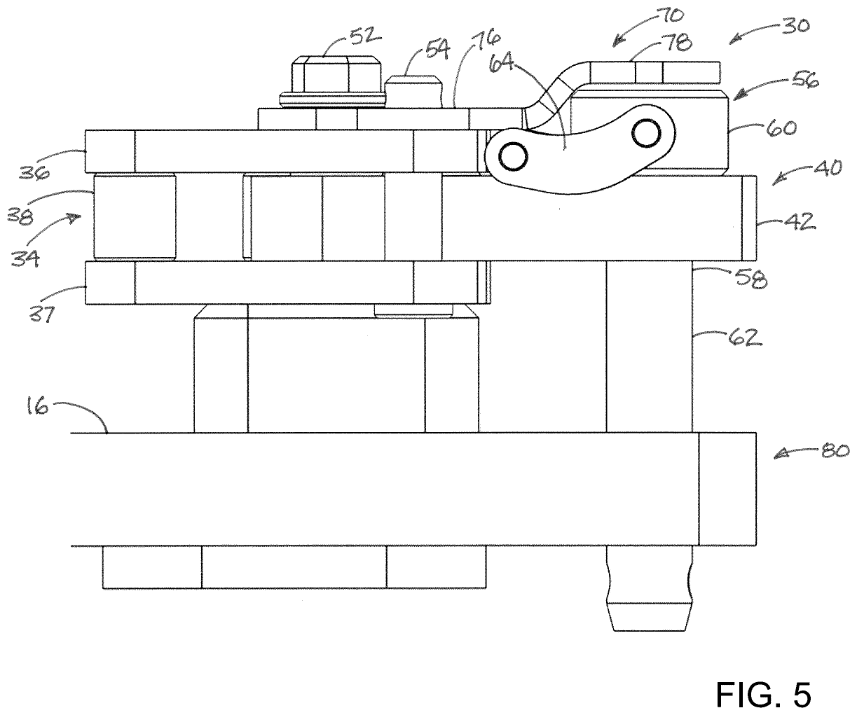

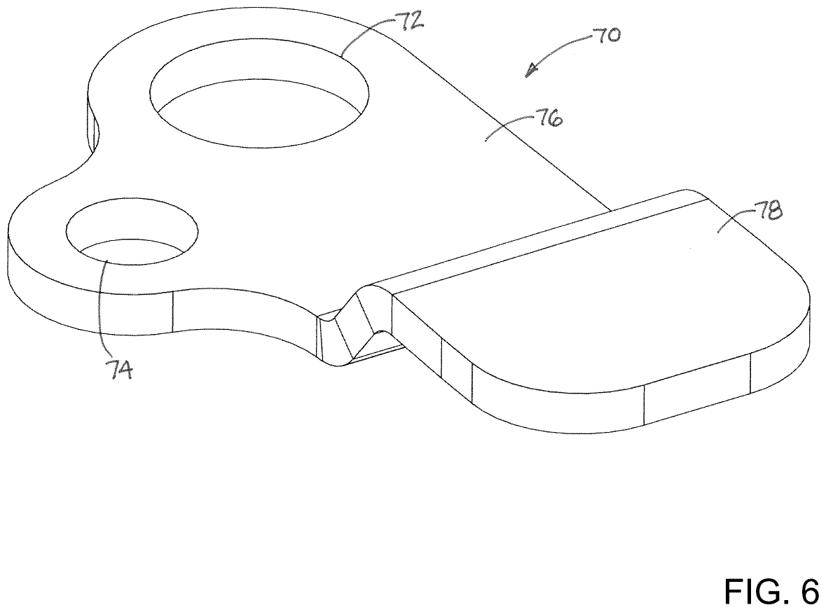

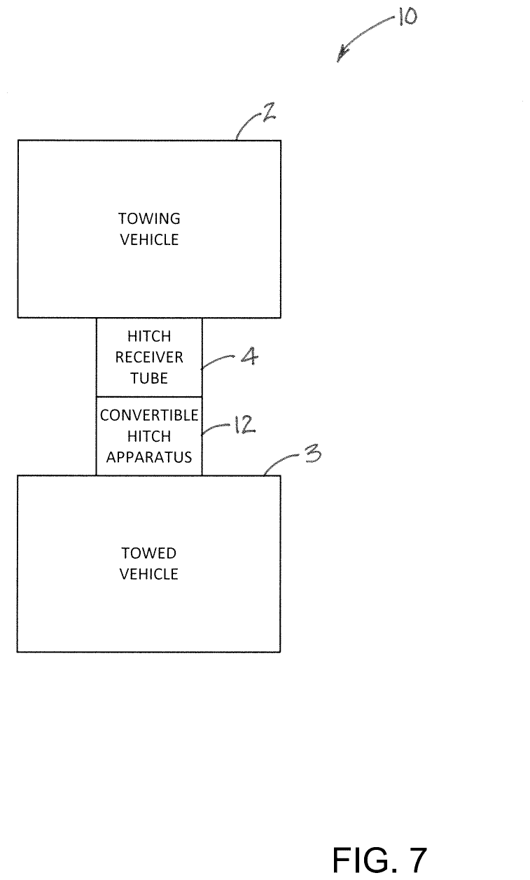

With reference now to the drawings, and in particular to FIGS. 1 through 7 thereof, a new trailer hitch system with a hitch pin keeper embodying the principles and concepts of the disclosed subject matter will be described.

The applicant has recognized that utilizing more than one of the different towing elements on a towing vehicle to match the variety of towing elements that may be present on different trailers has the disadvantage of requiring the user to absorb the expense of obtaining various towing elements, experience the hassle of maintaining storing the towing elements in a convenient location when not being utilized, and endure the laborious this of interchanging the towing elements when a trailer with different type of towing element is to be pulled.

The applicant has devised towing hitch apparatus which are convertible and thus highly adaptable to multiple different hitching structures, such as disclosed in U.S. Pat. No. 11,312,192 and U.S. Pat. No. 11,932,064, the disclosure of each of these patents being incorporated herein by reference in their entireties.

In general, disclosure relates to a hitch system 10 positioned between a towing vehicle 2 and a trailing vehicle 3 to connect the trailing vehicle to the towing vehicle for the purpose of towing or pulling the trailing vehicle behind the towing vehicle.

The hitch system 10 may comprise a hitch receiver tube 4 mounted on the towing vehicle 2, and the receiver tube may define a tube interior with an open end generally directed rearwardly with respect to the vehicle 2.

The hitch system 10 may include a convertible hitch apparatus 12 alone, or in combination with the towing vehicle 2. The hitch apparatus 12 may be removably mountable on the hitch receiver tube 4, such as by partial insertion into the tube interior of the tube 4. The hitch apparatus 12 may be elongated along a longitudinal axis 14, and a longitudinal direction may be defined by the longitudinal axis.

The hitch apparatus 12 may be convertible between a number of configurations for different hitch types, such as, for example, a clevis hitch configuration for supporting a clevis hitch pin, a ball hitch configuration for supporting a hitch ball, as well as other hitch configurations.

Embodiments of the convertible hitch apparatus 12 may include a mount structure 16 for mounting on the hitch receiver tube 4. In greater detail, the mount structure 16 may comprise an insertion portion 18 which may be at least partially insertable into the tube interior of the receiver tube 4. The insertion portion 18 may have an insertion end 20 insertable into the receiver tube, and the insertion portion may be provided with at least one securing bore for removably receiving a pin or bolt also inserted into holes of the hitch receiver tube 4 to retain the mount structure 16 on the receiver tube.

The mount structure 16 may also comprise a protrusion portion 24 that extends from the insertion portion 18. In some embodiments, the protrusion portion 24 may incorporate a vertical offset and have an upper section and a lower section shut that's harsh, with the upper section being located relatively higher and the lower section being located relatively lower when the hitch apparatus 12 is mounted on the receiver tube 4 for use.

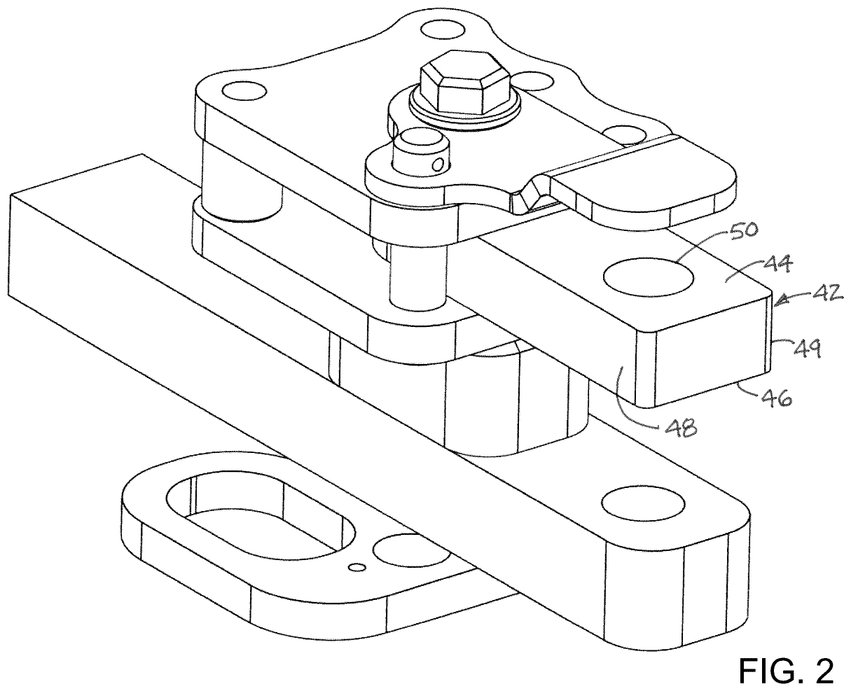

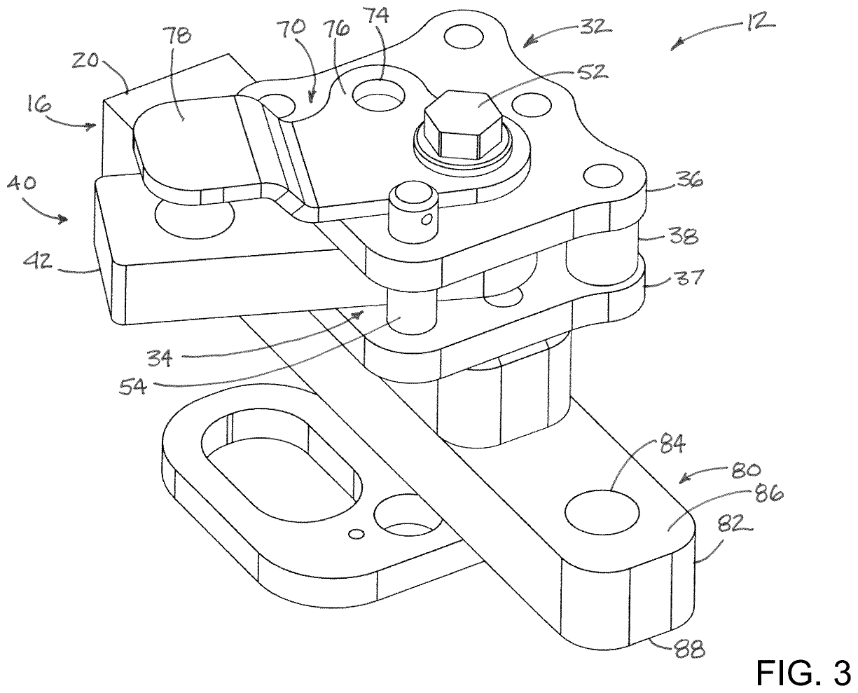

The convertible hitch apparatus 12 may include an upper hitch structure 30 located on the upper section 28 of the protrusion portion. The upper hitch structure 30 may generally have a deployed condition (see, e.g., FIGS. 1 and 2) and an inactive condition (see, e.g., FIG. 3), and the deployed condition may correspond to the clevis hitch configuration and the inactive condition may generally correspond to the ball hitch configuration.

The upper hitch structure 30 may include a support frame 32 which may be positioned above the protrusion portion 24 of the mount structure. The support frame 32 may define a slot 34 which may extend generally horizontally. In embodiments, the support frame 32 may include an upper member 36 and a lower member 37, and the upper and lower members may define the slot 34 therebetween. Illustratively, the upper member 36 may comprise an upper horizontal plate and the lower member may comprise a lower horizontal plate. At least one standoff element 38 may be positioned between the upper and lower horizontal plates to create a space between the plates forming the slot 34.

The upper hitch structure may further include an upper ball mount 40 mounted on the support frame 32. The upper ball mount 40 may be movably mounted on the support frame, and may be movable in the slot 34. The upper ball mount 40 may be movable between a deployed position (see, e.g., FIGS. 1 and 2) corresponding to the deployed condition of the hitch structure 30 and an inactive position (see, e.g., FIG. 3) corresponding to the inactive condition of the hitch structure. The deployed position may be generally characterized by the upper ball mount 40 extending parallel to the longitudinal axis 14 of the hitch apparatus, and the inactive position may be generally characterized by the upper ball mount extending substantially perpendicular to the longitudinal axis.

In the illustrative embodiments, the upper ball mount 40 includes a tongue element 42 that is pivotally mounted on the support frame. The tongue element 42 has an upper face 44 and a lower face 46 positioned opposite of each other on the element, and side faces 48, 49 which are positioned on opposite sides of the element and may extend between the upper and lower faces. The tongue element 42 may have a tongue aperture 50 extending between the upper 44 and lower 46 faces and the tongue aperture may be oriented along a substantially vertical axis when the hitch apparatus 12 is mounted for use.

The upper ball mount 40 may also include a pivot pin 52 mounting the tongue element 42 on the support frame 32. In illustrative embodiments, the pivot pin 52 may extend through the upper member 36 of the support frame and into the lower member 37 of the frame. The pivot pin 52 may extend along a substantially vertical axis when the hitch apparatus 12 is mounted for use to permit pivoting of the tongue element with respect to the support frame in a substantially horizontal plane.

The upper ball mount 40 may further include a locking pin 54 configured to selectively block the tongue element 42 from movement out of the deployed position, and may also be configured to selectively block the tongue element from movement out of the inactive position. The locking pin 54 may be extendable into the support frame 32 in each of the deployed and inactive positions of the tongue element of the upper ball mount. The locking pin 54 may extend along a substantially vertical axis when inserted into the support frame 32 and the apparatus 12 is mounted for use. Illustratively, the locking pin 54 may extend through the upper member 36 and into the slot 34 where the presence of the pin 54 may at least partially interfere with pivoting of the tongue element. The locking pin 54 may also extend into the lower member 37 when the pin extends through the upper member. In illustrative embodiments, the locking pin 54 may not be extended through the upper ball mount tongue element 42 in the deployed position of the upper ball mount, and may not be extended through the tongue element in the inactive position of the upper ball mount,

The upper ball mount 40 may include a hitch pin 56 removably mounted on the tongue element 42, and the hitch pin may be removably inserted into the tongue aperture 50 of the tongue element. The hitch pin 56 may be elongated with a first end 58. The pin 56 may have a head portion 60 located at the first end of the pin and a shaft portion 62 extending from the head portion. The head portion 60 may be enlarged in size with respect to the shaft portion 62 such that the shaft portion is insertable into the tongue aperture and the head portion is unable to move into and/or through the tongue aperture. In some embodiments, the head portion 60 may include a loop 64.

The convertible hitch apparatus 12 may also include a hitch pin retaining element 70 that is configured to selectively retain the hitch pin 56 on the tongue element 42, such as by keeping the hitch pin inserted into the tongue aperture. As such, use of the hitch retaining element 70 may avoid the use of a cotter pin inserted through the shaft portion 62 of the hitch pin may be avoided. The hitch pin retaining element 70 may be movable, such as between a retaining position (see, e.g., FIGS. 1 and 2) and a release position (see, e.g., FIG. 3). The retaining position may be characterized by the retaining element 70 extending adjacent to the hitch pin 56 in a manner blocking movement of the hitch pin 56 out of the tongue aperture when the ball mount 40 is in the deployed position and the hitch pin is inserted into the tongue aperture. The release position may be characterized by the retaining element 70 being moved out of adjacency to the hitch pin 56 when the hitch pin is inserted into the tongue aperture in a manner that may permit movement of the pin out of the tongue aperture. The hitch pin retaining element 70 may be movably mounted on the support frame 32 to permit movement between the retaining and release positions, and may be pivotable with respect to the support frame. In embodiments, the retaining element 70 may be pivotable independently of the tongue element 42 to permit the upper ball mount 40 to be in the deployed position without the retaining element being in the retaining position, such as when the hitch pin 56 is being initially inserted into the tongue aperture 50. The retaining element 70 may pivot about a substantially vertical axis in a substantially horizontal plane when the apparatus 12 is mounted for use. Illustratively, the retaining element 70 may rest upon the upper member 36 of the support frame.

In the illustrative embodiments, the retaining element 70 is mounted on the support frame by the pivot pin 52, and the pivot pin may extend through the retaining element and into the support frame such that the retaining element rotates about the pivot pin. The retaining element 70 may have a pivot pin aperture 72 for receiving the pivot pin.

Additionally, the retaining element 70 of the illustrative embodiments is selectively secured in the retaining position by the locking pin 54. The retaining element 70 may have a pin aperture 74 that is configured to receive the locking pin 54 when the retaining element is in the retaining position, and the locking pin 54 may extend through the retaining element and into the support frame 32.

In embodiments, the retaining element 70 includes a support portion 76 that is positioned adjacent to the support frame 32, and may rest on the support frame. The support portion 76 may have the pivot pin aperture 72, and the pivot pin may extend through the support portion. The retaining element 70 may include a blocking portion 78 that extends from the support portion 76, and the blocking portion may be positioned adjacent to the hitch pin 56 when the hitch pin is inserted into the tongue aperture 50 and the tongue element 42 of the upper ball mount is positioned in the deployed position. Illustratively, the blocking portion 78 may be located in a plane that is offset with respect to the plane of the support portion. Optionally, a section of the blocking portion 78 may be configured to be insertable into the loop 64 of the hitch pin.

The convertible hitch apparatus 12 may also include a lower hitch structure 80 which may be located on the lower section 29 of the insertion portion. The lower hitch structure 80 may comprise a lower ball mount 82 mounted on the mount structure 16, and may be immovable with respect to the support frame 32 of the upper hitch structure. The lower ball mount 82 may have a lower ball mount aperture 84 that extends between an upper face 86 and a lower face 88 of the lower ball mount. The lower ball mount aperture 84 may receive a section of the shaft portion 62 when a section of the shaft portion is also inserted into the tongue aperture 50 of the tongue element of the upper ball mount in the deployed position. Optionally, a hitch ball may be mounted via the lower ball mount aperture 84 on the lower ball mount when, for example, the upper ball mount is in the inactive position. As a further option, the lower ball mount aperture 84 may receive a pin extending between the vertically spaced tabs of a hitch structure for clevis hitch configuration.

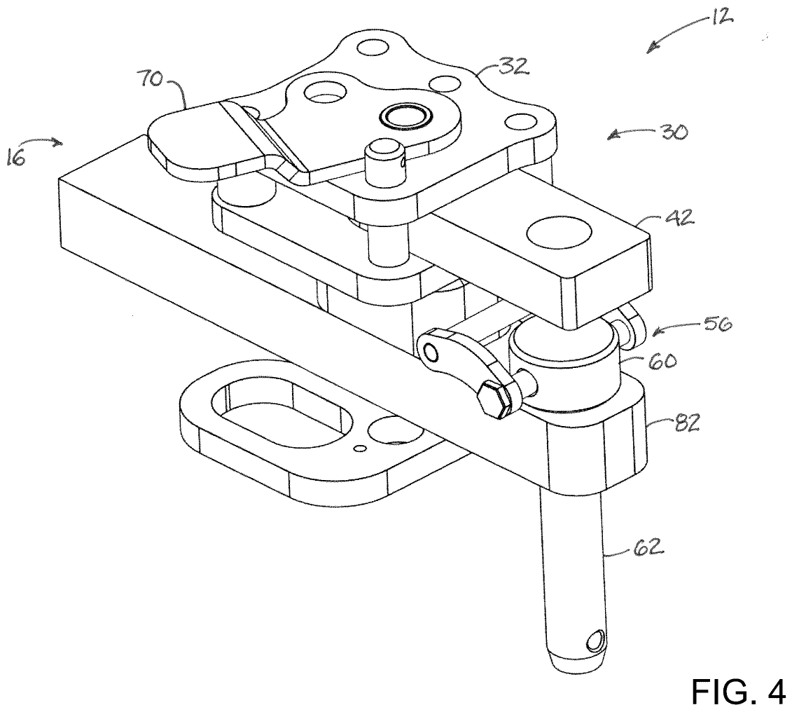

An additional configuration of the convertible hitch apparatus 12 may have the upper hitch structure 30 in the deployed condition with the hitch pin 56 extended through the lower ball mount aperture 84 with the head portion 60 resting upon the lower ball mount 82, but without having the shaft portion 62 extended through the tongue aperture 50 of the tongue element (see, e.g., FIG. 4). The retaining element 70 may be in the release position as the tongue element 42 may effectively block movement of the hitch pin from the lower ball mount aperture.

It should be appreciated that in the foregoing description and appended claims, that the terms “substantially” and “approximately,” when used to modify another term, mean “for the most part” or “being largely but not wholly or completely that which is specified” by the modified term, and may be further quantified as values or qualities which deviate approximately 10 percent or less from the value or quality or relationship stated in the disclosure.

It should also be appreciated from the foregoing description that, except when mutually exclusive, the features of the various embodiments described herein may be combined with features of other embodiments as desired while remaining within the intended scope of the disclosure.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

I claim:

1. A convertible hitch apparatus for removably mounting on a hitch receiver tube of a vehicle, the hitch apparatus being elongated along a longitudinal axis, the apparatus comprising:
a mount structure for mounting on the hitch receiver tube, the mount tube assembly comprising:
an insertion portion at least partially insertable into a tube interior of the receiver tube; and
a protrusion portion extending from the insertion portion;
a lower hitch structure including a lower ball mount on the mount structure;
an upper hitch structure on the mount structure above the lower hitch structure, the upper hitch structure having a deployed condition and an inactive condition,
the upper hitch structure comprising:
a support frame on the protrusion portion;
an upper ball mount movably mounted on the support frame, the upper ball mount comprising:
a tongue element movably mounted on the support frame to pivot between a deployed position corresponding to the deployed condition and an inactive position corresponding to the inactive condition, the tongue element having a tongue aperture;
a pivot pin pivotally mounting the tongue element on the support frame;
a locking pin removably mountable on the support frame in a manner such that the locking pin selectively blocks the tongue element in the deployed position;
a hitch pin removably insertable into the tongue aperture of the tongue element; and
a hitch pin retaining element for selectively blocking removal of the hitch pin from the tongue aperture.

2. The apparatus of claim 1 wherein the hitch pin retaining element is movable between a retaining position and a release position;
wherein the retaining position is characterized by the retaining element extending adjacent to the hitch pin when the hitch pin is inserted into the tongue aperture in a manner blocking movement of the pin out of the tongue aperture; and
wherein the release position is characterized y the retaining element being moved out of adjacency to the hitch pin when the hitch pin is inserted into the tongue aperture in a manner permitting movement of the pin out of the tongue aperture.

3. The apparatus of claim 1 wherein the hitch pin retaining element is pivotally mounted on the support frame such that the retaining pivots between the retaining and release positions.

4. The apparatus of claim 1 wherein the hitch pin retaining element is mounted on the support frame by the pivot pin.

5. The apparatus of claim 1 wherein in the hitch pin retaining element is selectively securable in the retaining position by the locking pin.

6. The apparatus of claim 5 wherein the retaining element has a pin aperture configured to receive the locking pin when the retaining element is in the retaining position, the locking pin extending through the retaining element and into the support frame.

7. The apparatus of claim 1 wherein the support frame defines a slot, the upper ball mount being movable in the slot of the support frame.

8. The apparatus of claim 1 wherein the deployed position of the upper ball mount is characterized by the upper ball mount extending parallel to the longitudinal axis of the hitch apparatus, the inactive position is characterized by the upper ball mount extending substantially perpendicular to the longitudinal axis of the hitch apparatus.

9. The apparatus of claim 1 wherein the locking pin is removably mountable on the support frame in a manner such that the locking pin selectively blocks the tongue element in the inactive position.

10. The apparatus of claim 1 wherein the locking pin is extendable into the support frame in each of the deployed and inactive positions of the upper ball mount.

11. The apparatus of claim 10 wherein the support frame includes an upper member and a lower member, the upper and lower members defining a slot therebetween in which a portion of the tongue element is positioned.

12. The apparatus of claim 11 wherein the locking pin is extendable through the upper member and into the slot to block movement of the tongue member in the slot.

13. The apparatus of claim 12 wherein the locking pin extends into the lower member when the pin is inserted into the upper member and the slot.

14. The apparatus of claim 11 wherein the upper member comprises an upper horizontal plate and the lower member comprises a lower horizontal plate, at least one standoff element being positioned between the upper and lower plates.

15. The apparatus of claim 1 wherein the lower ball mount is immovable with respect to the protrusion portion of the mount structure.

16. The apparatus of claim 1 wherein the retaining element includes:
a support portion positioned adjacent to the support frame, the support portion having a pivot pin aperture through which the pivot pin extends; and
a blocking portion extending from the support portion, the blocking portion extending adjacent to the hitch pin when the hitch pin is inserted into the tongue aperture and the retaining element is in the retaining position.
